(19) United States
(12) Patent Application Publication
(10) Pub. No.: US 2006/0190563 A1
(43) Pub. Date: Aug. 24, 2006

(54) High-volume web page update system and method

(76) Inventor: Richard J. Vann, Orinda, CA (US)

Correspondence Address: CONLEY ROSE, P.C., 5700 GRANITE PARKWAY, SUITE 330, PLANO, TX, 75024, US

(21) Appl. No.: 11/062,410

(22) Filed: Feb. 22, 2005

(51) Int. Cl. G06F 15/16

(52) U.S. Cl. 709/219

(57) ABSTRACT

A system is provided for updating a web page. The system includes a device and a server, the device is provided behind a firewall, and displays a web page. The device limits the display of information asynchronously transmitted to the device, and is further operable to request information. The server is provided outside the firewall. The server is in communication, via a connection, with the device. In response to a request from the device for information, the server provides the information to the device. The server is also operable to facilitate maintaining the connection with the device such that when the information is updated the server communicates the updated information to the device via the connection.

### CROSS-REFERENCE TO RELATED APPLICATIONS

The present application contains subject-matter related to U.S. patent application Ser. No. 10/730,624, filed Dec. 8, 2003, entitled “Auction System for Remote Bidding and Method,” and to U.S. patent application Ser. No. 10/423,583, filed Apr. 25, 2003, entitled “Interactive Remote Auction Bidding System,” which is a continuation in part of U.S. patent application Ser. No. 10/005,808, filed Dec. 3, 2001, entitled “Interactive Remote Auction Bidding System,” which is a continuation-in-part of U.S. patent application Ser. No. 09/086,877 filed May 29, 1998, entitled “Interactive Remote Auction Bidding System,” issued on Jul. 2, 2002, as U.S. Pat. No. 6,415,269, all of which are incorporated herein by reference for all purposes.

### STATEMENT REGARDING FEDERALLY SPONSORED RESEARCH OR DEVELOPMENT

Not Applicable.

### TECHNICAL FIELD OF THE INVENTION

The present invention relates to the updating of web pages, including but not limited to those used by auction systems.

### BACKGROUND OF THE INVENTION

Applications and content are commonly provided via the Internet to desktops using web browsers. The web browsers request the web pages and/or content from remote systems or servers and receive and display the content upon receipt. The continual requesting of information creates overhead that may cause inefficiencies in systems, such as where information critical for decision making is not timely provided to remote desktop browsers.

There are countless examples of systems and applications that provide information via the Internet. Auctions are one example of activities where such systems are employed. Although auctions are described for purposes of illustration, the present disclosure should in no way be limited to auction environments or auction systems, and has application in countless other activities and applications.

Auctions are a centuries old process. Scale (quantity of product and number of attendees) and reach (distance buyers or goods travel to participate in the auction) remain key factors determining the success of an event. The more valuable the item, the more unique its market, the greater the distance that the product and buyer travel to achieve needed scale. Certain commodities (such as valuable equipment, boats, trophy properties, general aviation aircraft) which may appear well suited to auction processes, but are rarely sold in this manner because of the difficulty achieving scale and reach while retaining live auction elements necessary to attract buyers.

Remarketing surplus products is a challenge for manufacturers and dealers in many industries, and in particular the equipment industry. Stale new inventory and “slightly used” product competes for customers with goods direct from the assembly lines. Equipment ownership and usage patterns have changed and continue to change. Whereas most new product was once sold to end users, now many industry segments deliver more than 65% of new product to “Rental/Lease Fleets”. Equipment sold is often guaranteed for its future value. Customers have transferred many elements of ownership risk to manufacturers and dealers by forcing sellers to provide rentals, leases, or future value guarantees.

Consumer preference to rent is driven by a composite of factors including tighter lending standards, lack of tax incentives, increasing complexity and specialization of equipment, volatility of equipment values within their industries and increasing availability and competitiveness of short term equipment rental solutions. Rentals, long-term leases, and “buy back” agreements provide customers use of equipment without the ownership obligations or liabilities. Manufacturers and dealers remain “at risk” and responsible for rental, lease and “buy back” equipment until its ultimate sale.

In view of these marketing techniques, as well as improvements in the useful life of a product, the burden of remarketing more of these products after their first substantial use remains with manufacturers, dealers and other rental operators. In many cases, the most severe competition for new sales is generated by identical “used product” rather than by new product of competitive manufacturers.

Manufacturers and dealers have achieved success generating sales of new products, but typically have less success remarketing used equipment and transferring ownership obligations to end users. “After market” remarketing specialists such as brokers, traders, import-export entrepreneurs and retail auctioneers provide needed expertise for second and subsequent sales of equipment. These remarketing specialists sell in direct competition to new products sold by dealers and manufacturers.

Due to the diverse demographics of their markets and fractured communication among dealers, dealers' effectiveness is typically limited to small geographic areas in proximity to their dealerships. Dealers typically have limited knowledge or success trading outside local trading areas. Manufacturers encourage “local” market focus. Whereas “local” focus for new equipment may be effective, remarketing surplus equipment locally limits potential and is largely an ineffective and costly strategy. At the same time, effort expended, travel costs, language, currency, cultural and information barriers plus lack of critical mass in any single market make venturing beyond local trade areas expensive, risky, inefficient, and often counterproductive for dealers. Accordingly, remarketing used equipment has been inefficient.

Conventionally, auctions of used equipment or the like require that the equipment be brought to the auction site and presented by the seller where the auction takes place. Additionally, all participants to the auction must assemble at the auction site. Such an auction therefore is typically limited to regional geographic areas due to the costs of assembling equipment as well as participants. Scale is crucial to auction success. Scale attracts buyers. The more buyers the better the result. The more specialized the product, the greater the distance both buyer and product must travel for the auction to achieve scale or critical mass. Freight on large equipment is expensive, and moving equipment to an auction site, and then removing the same equipment, if not sold, produces an inefficient non-value added expense. These expenses are further incurred by buyers traveling to auctions.

Similarly, auctions for expensive or unique goods (such as art or horses, for example) will likewise receive significant benefit from the ability to less expensively bring scale to the auction (they do not have to move all of the goods to the auction site) and/or scale to the number of participants (they do not have to move all of the participants to the auction site). Advantages may be provided by a “real-time” auction information processing system, which enables individuals dispersed over a wide geographic area to participate in an auction without gathering at the auction site. Advantages may also be provided by a system to allow individuals to participate in an auction without requiring a large investment in a technical infrastructure at the buyers'/bidders' remote locations.

### SUMMARY OF THE INVENTION

In accordance with one embodiment, a system is provided for updating a web page. The system includes a device and a server, the device is provided behind a firewall, and displays a web page. The device limits the display of information asynchronously transmitted to the device, and is further operable to request information. The server is provided outside the firewall. The server is in communication, via a connection, with the device. In response to a request from the device for information, the server provides the information to the device. The server is also operable to facilitate maintaining the connection with the device such that when the information is updated the server communicates the updated information to the device via the connection.

In one embodiment, the present disclosure provides software for updating a web page. The software includes a remote program and a webcaster program. The remote program includes substantially hyper-text markup language (HTML) code that is used by a web browser provided behind a firewall. The remote program displays a web page and requests information. The display in the web page of information asynchronously transmitted is restricted. The webcaster program is deployed outside the firewall. The webcaster program communicates, via a connection, with the remote program. Responsive to a request from the remote program for information, the webcaster program provides the information. The webcaster program facilitates maintaining the connection with the remote program such that when the information is updated the webcaster program communicates the updated information to the remote program via the connection.

In another embodiment, a system for broadcasting an update to a web page is provided. The system includes a first software routine operable to send a request for information to a second software routine. The system includes a second software routine operable to communicate via a connection to return the information to the first software routine each time the information is updated to the second software routine. The second software routine maintains the connection after transmitting the information to the first software routine so that additional updated information may be received by the second software routine may be transmitted to the first software routine. The system also includes a web page to display the information received from the first software routine.

In yet another embodiment, a method is provided for broadcasting an update to a web page. The method includes a HTML (hyper-text markup language) web page executing in a browser behind a firewall. The method includes sending a request for information to a webcaster software outside of the firewall. The method provides that a socket connection is established for communication between the webcaster software and the HTML web page. In response to the request for information from the HTML web page, the webcaster software returns the information to the HTML web page. As the information is updated to the webcaster software, the webcaster software maintains the socket connection to provide the updated information to the HTML web page via the socket connection.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a block diagram, according to one embodiment, of a system for high-volume, real-time web page updating.

FIG. 2 is a block diagram of another embodiment of the system for high-volume web page updating.

FIG. 3 is a flow chart illustrating a method for system for high-volume web page updating, according to another embodiment.

### DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein.

An interactive remote auction bidding system might be used to conduct an auction among participants located at remote locations. An example of such a system is disclosed in U.S. patent application Ser. No. 10/730,624, filed Dec. 8, 2003, entitled “Auction System for Remote Bidding and Method,” which is hereby incorporated by reference for all purposes. In such a system, bidders at remote locations can communicate with an auction control system via a communications network. Bidders might send data to and receive data from the auction control system by means of a communication device such as a conventional telephone, a wireless telephone, a personal computer, a personal digital assistant, or a similar device. The communication device might include a display that can graphically present data received from the auction control system.

The present disclosure, according to one embodiment, is directed to a system and method for updating information for numerous web browsers pages in a timely and efficient manner. These updates may be pushed from a server to the web browsers, in some embodiments, without any action by the user and regardless of whether the web browser is behind a firewall. In certain arenas, such as but not limited to live auctions, where delivery of time-critical information is necessary or provides additional value and where such delivery has previously been difficult to achieve, the present disclosure may provide additional value. The present disclosure may be discussed and described in application in auction environments, but the present disclosure is not limited to this application and those skilled in the art will readily identify other applications, all of which are within the spirit and scope of the present disclosure and claims.

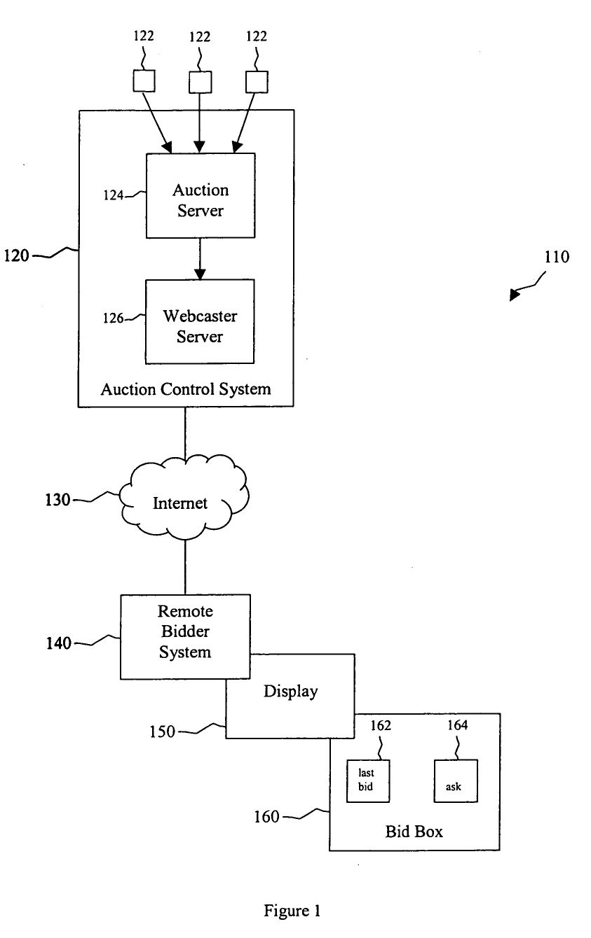

FIG. 1 illustrates an embodiment of an interactive remote auction bidding system 110, which may employ the system and method of the present disclosure. In this embodiment, an auction control system 120 communicates with a remote bidder system 140. The auction control system 120 may include one or more computer systems, such as network servers, and various components for receiving, transmitting, processing, and displaying auction-related information. In the embodiment of FIG. 1, the auction control system 120 includes an auction server 124 and a webcaster server 126. The auction server 124 controls one or more auctions by receiving bids, keeping track of bids and other auction information, and sending auction information to the webcaster server 126. A plurality of telephones or other data input devices 122 can send bid information to the auction server 124.

Whenever there is an update to the auction information, when a bidder places a bid, for example, the auction server 124 sends the updated information to the webcaster server 126. The webcaster server 126 can communicate with the Internet 130 or some other communications network to broadcast the updated information.

The remote bidder system 140 may be a standard computer system that can access the Internet 130, such as by using a web browser. A bidder or user of the remote bidder system 140 may view auction information over the Internet 130 where the webcaster server 126 has broadcast the information, such as by a webcast or otherwise to an Internet locale accessible by the remote bidder system 140. Via the remote bidder system 140, a bidder may log into a website and view the current bid, ask, and other auction information, view pictures and streaming audio and/or video, and place bids.

The remote bidder system 140 is not limited to a computer and may be any device operable to access the auction control system 120, via the Internet 130 or otherwise, such as, but not limited to, a personal digital assistant (PDA), a wireless or other telephone or device, or other devices or systems now employed or developed hereafter with such capability. For the sake of clarity in the drawing, only one remote bidder system 140 is shown in FIG. 1, but multiple remote bidder systems 140 would typically participate in an auction.

The auction control system 120 might communicate with the remote bidder system 140 via the Internet 130 or via a private or dedicated network. The communication between the auction control system 120 and the remote bidder system 140 may or may not be encrypted or otherwise securely transmitted. Where encryption is used, secure socket layer (SSL) or other encryption technologies may be employed, and a virtual private network (VPN) and/or additional security measures may be employed.

The remote bidder system 140 may receive a plurality of images, such as graphic files, of the subject matter of the auction, which may be periodically cycled or scrolled for viewing on a display 150. The display 150 may also provide the bidder with useful information about the subject matter of the auction, including quality, history, seller, opening price, closing price, sold price, and messages such as “reserve not attained.” These items are not shown in FIG. 1 for the sake of clarity in the drawing. The display 150 may also include a bid box 160 to provide the bidder with the current bid pricing information, such as last bid 162 and current ask 164, for the subject of the auction.

Bid information such as the last bid 162 and the current ask 164 changes during the course of the auction as bidders place bids. It is desirable that such information be transmitted from the auction control system 120 to the remote bidder systems 140 as soon as possible after a change occurs so that the bidders can view the most up-to-date information.

The updating of the bid box 160 might be accomplished in several manners. A simple way for the bid box 160 to be updated would be for a bidder to click on a Refresh button on a web browser. This can reload a web page that contains the display 150 and cause the updated auction information to be transmitted from the auction control system 120 to the remote bidder system 140. This technique may be undesirable since it requires an action from the bidder. Different bidders might refresh their browsers at different times, possibly causing each bidder to view different auction information. This could cause confusion in the placing and processing of bids. It is preferable that the auction control system 120 update the bid box 160 automatically, without the need for action from the bidders.

Another possibility for the updating of the bid box 160 is for the auction control system 120 to initiate a connection to each remote bidder system 140 and send updated auction information to the remote bidder systems 140 whenever the auction information changes. It may be impractical, in some instances, to implement such a solution due to the security measures that typically exist between the auction control system 120 and the remote bidder systems 140. The remote bidder system 140 would typically be located behind a firewall or similar security system. Most firewalls do not allow a client, such as the remote bidder system 140, to accept an unsolicited message from a server, such as the auction control system 120.

Another technique that might be used to update the bid box 160 is for the remote bidder system 140 to periodically poll the auction control system 120 for the current auction information. This technique may be useful where the remote bidder system 140 is behind a firewall or other security system that might reject an unsolicited signal sent from the auction control system 120. If a remote bidder system 140 polls or requests the information from the auction control system 120, the return signal from the auction control system 120 would typically be permitted to pass such a security system to reach the remote bidder system 140.

This technique can be less than desirable for high-volume web page broadcast updates because of the time and resources needed to open the connections for the polling events. This method also has a longer response time then this invention due to both polling period and time to establish a new connection. To keep the bid box 160 up-to-date, the remote bidder system 140 may need to poll the auction control system 120 for new information at a high frequency, possibly every second or even more often. Each time a remote bidder system 140 polls the auction control system 120, a new TCP/IP connection would typically be opened between the remote bidder system 140 and the auction control system 120. The auction control system 120 would then send the auction information to the remote bidder system 140 and the TCP/IP connection would be closed.

Each opening and closing of a TCP/IP connection can consume some amount of time and computing resources. When large numbers of remote bidder systems 140 are polling the auction control system 120, a great deal of computing capacity may be needed to handle the requests. If the computing capacity of the auction control system 120 is insufficient, delays could occur in returning auction information to the remote bidder systems 140. This could cause different bidders to see different auction information and cause confusion in the auction process. Adding sufficient computing capacity to handle a large number of nearly simultaneous openings and closings of TCP/IP connections could create a large expense for the owner of the auction control system 120.

The present disclosure addresses some of these limitations to maintaining up-to-date bid information. According to one embodiment, multiple web browsers may be updated with auction information almost immediately after the auction information changes. The updates can occur through typical firewalls and do not require any action on the part of participants in an auction. There is no need for a remote bidder system to frequently poll an auction control system for updated auction information.

In various embodiments, a web browser sends a request for auction information to an auction control system. Once the current information has been sent, the auction control system may hold the request and may not return any auction information until new auction information is available to the auction control system. In other embodiments, the auction control system may return the current information maintained by the auction control system. After the new auction information is sent, the connection between the auction control system and the browser remains open. This connection may be a TCP/IP or other socket or connection type(s). Thereafter, whenever any change occurs in the auction information, the updated auction information is sent almost immediately to the web browser over the open connection. In this manner, a web browser can be updated in near real-time, without the inefficiencies, overhead, additional time or resources of multiple openings and closings of TCP/IP connections between the browser and the auction control system.

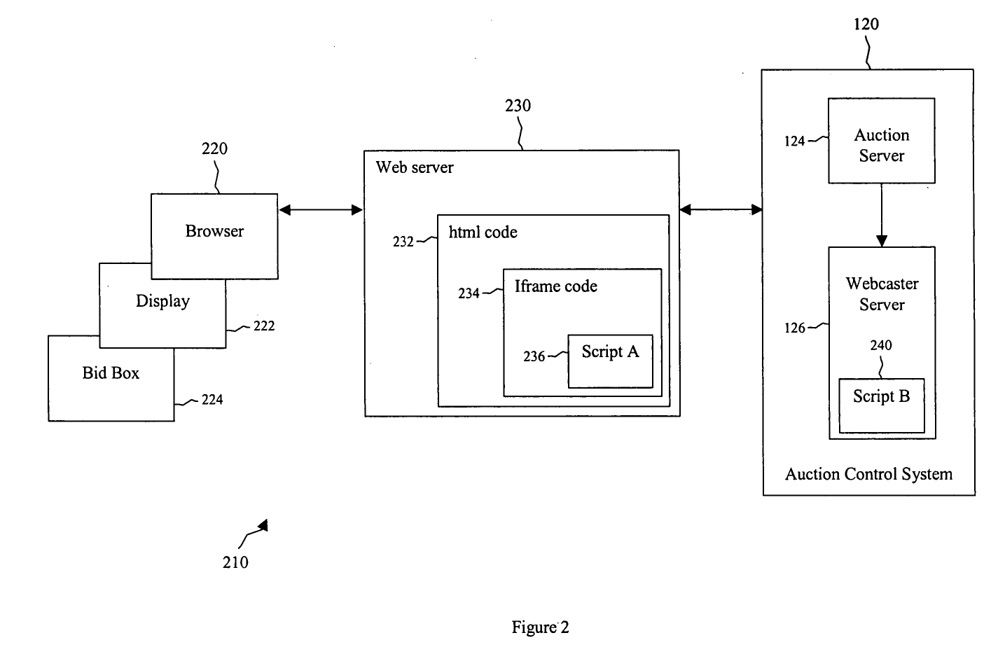

Referring to FIG. 2, an embodiment of a high-volume web page update system is illustrated and is generally identified by the numeral 210. A web browser 220 allows a bidder to view auction information. The web browser 220 presents a display 222 that might be similar to the display 150 shown in FIG. 1. A portion of the display 222 consists of a bid box 224 that might be similar to the bid box 160 shown in FIG. 1. That is, the bid box 224 might display the last bid, the ask, and other auction information that needs to be kept up-to-date.

A web server 230 hosts a file containing html code 232 that specifies the parameters for a web page that can contain the bid box 224 and other auction information. The browser 220 can read and interpret the html code 232 to create the web page on the display 222. A portion of the html code 232 is code 234 that is capable of creating an Iframe. As is well known in the art, an Iframe is an HTML capability that allows a portion of a web page to be retrieved from a location different from the source of other portions of the same web page. Iframes might be used to modify the text and/or graphics in one section of web page while the rest of the web page stays unchanged.

It is also well known in the art that an Iframe can be hidden so that it does not have any effect on the appearance of a web page, but instead performs some type of background action. In the embodiment of FIG. 2, the Iframe code 234, which is part of the html code 232, creates a hidden Iframe and causes a script or other software routine to be executed that causes a request to be made for auction information. This script or other software routine is referred to in FIG. 2 as script A 236. When script A 236 receives or obtains auction information, it provides the auction information to the browser 220 and updates the bid box 224 with the auction information.

In an embodiment, script A 236 sends a request for auction information to the webcaster server 126, which may contain another script or other software routine. This script or other software routine is referred to in FIG. 2 as script B 240. Script B 240 may be capable of sending auction information from the webcaster server 126 to the browser 220. In an embodiment, the auction information is transmitted in the form of a parameter of a function call made from script B 240 to script A 236.

Whenever any auction information changes, the auction server 124 sends the updated data to the webcaster server 126. Thus, the most up-to-date auction information is always available to script B 240. In an embodiment, script B 240 may not respond to intermittent requests from script A 236 for auction information until a change in the auction information occurs. After script B 240 responds, the connection between the web server 230 and the auction control system 120 is maintained so that script B 240 can transmit any further changes in the auction information to script A 236 without script A 236 making additional requests for information.

This can be contrasted with a traditional manner in which data is transferred from a server to a client. Traditionally, when a client sends a request for data, a TCP/IP connection is opened between the client and the server, the request is sent to the server, the server immediately returns the requested data, and the TCP/IP connection is closed. If an update of the data is needed, a user might click a Refresh button in a web browser and a new TCP/IP connection would be opened to transmit the new data and then closed again.

In various current embodiments, the webcaster server 126 is programmed to communicate with the browser 220 and/or web server 230 in this manner to facilitate maintaining the TCP/IP connection after sending the auction information. More specifically, the browser 220 reads the html code 232 and reaches the portion of the html code 232 that contains the Iframe code 234. The Iframe code 234 includes an “SRC” attribute of the Iframe which defines the URL (universal resource locator) initially retrieved by the Iframe and used to fill its contents. The Iframe is set to an empty html page, which is specified as “null.htm”. Thus, the Iframe makes an http request by setting its “SRC” attribute to some URL. The response is a web page that contains its own javascript that executes or is loaded into the Iframe on the current html page. At some point, a TCP/IP connection is established between the web server 230 and/or the browser 220 and the webcaster server 126. Script A 236 within the Iframe code 234 then sends a request for auction information, via the TCP/IP connection, to script B 240 within the webcaster server 126. Script B 240 respond to this request. As soon as the webcaster server 126 receives new auction information, script B 240 returns the auction information to script A 236 via the TCP/IP connection. In this manner, the TCP/IP connection remains open for future updates of the auction information.

When script A 236 receives the auction information from script B 240, script A 236 sends the auction information to the browser 220, which then updates the bid box 224 with the auction information. When any change occurs in the auction information, the auction server 124 sends the updated data to the webcaster server 126. Script B 240 then sends the updated data, via the still open TCP/IP connection, to script A 236, which then causes the browser 220 to update the bid box 224.

The initial web page is fully loaded before any data communication with the web server takes place. So there are initially two connections, a first to get the “frame” html page from the webcaster server 126, and a second to get the initial data from the webcaster server 126. The second connection is made by changing the “SRC” attribute of the Iframe and remains open as if a page (for the Iframe) that has not completely downloaded. When the web browser 220 reads the section of the html code 232 that contains script A 236, script A 236 sends a request for auction information to script B 240. Script B 240 sends the auction information to script A 236 whenever a change occurs in the auction information. Script A 236 sends the auction information to the browser 220, which then displays the auction information in the bid box 224. In some embodiments, the webcaster server 126 and/or Script B 240 promote maintaining this connection. Since the TCP/IP connection remains open, script A 236 acts or considers that it has not received a complete response to its request for auction information. Thus, script A 236 does not complete its execution and this may cause the html code 232 and/or browser 220, in turn, to not complete its execution, and wait for more data as if the web page is continuing to download from the web server 230. Since the Iframe that contains script A 236 is hidden, the appearance of the web page is normal even though script A 236 does not complete its execution.

It should be understood that other physical and logical configurations of the components shown in FIG. 2 are possible. For example, the html code 232, the Iframe code 234, and script A 236 might all reside on the web server 230 as shown, each of those items might reside on separate servers, or various combinations of those items might reside on separate servers. Similarly, script B 240 might reside on a server other than the webcaster server 126. Script A 236 and/or the Iframe code 234 may be embedded within the html code 232 or the html code 232 may call script A 236 and/or the Iframe code 234, which may reside elsewhere. Also, the auction server 124, the webcaster server 126, and the web server 230 might be separate devices as shown or various combinations of those items might be combined into a single device. In addition, portions of the html code 232, the Iframe code 234, and/or script A 236 might reside on a client-side device, such as for example a desktop computer, that also hosts the browser 220. Other arrangements of hardware and software that perform functions similar to those described above will be evident to one of skill in the art.

For various reasons, it may be undesirable to keep a TCP/IP connection open for an extended period of time. In an embodiment, the TCP/IP connections between multiple browsers 220 and the auction control system 120 are periodically closed so that the resources being consumed to hold the connections open can be recycled. The TCP/IP connections are then promptly reopened so that, from the perspective of the bidders, the disconnection is not evident.

Closing and reopening every TCP/IP connection simultaneously could place a considerable burden on the web server 230 and/or the auction control system 120. For example, if ten minutes is designated as the period of time for each TCP/IP connection to remain open before being recycled, a peak of closings and reopenings will occur every ten minutes. To prevent such a spike, the closings and reopenings can be distributed over time. That is, a first group of connections might be recycled one minute after an auction begins, a second group of connections might be recycled two minutes after the auction begins, a third group after three minutes, etc. The first group might then be recycled 11 minutes after the beginning of the auction, the second group might be recycled after 12 minutes, the third group after 13 minutes, etc. In this way, small groups of connections can be recycled on some interval rather than all connections being recycled every ten minutes. It should be clear that other periods of time could be used.

Some variations may occur in various embodiments depending on the type of web browser that is used to retrieve auction information. The above discussion has focused primarily on Internet Explorer-type browsers. Some browsers, such as Microsoft Internet Explorer for example, will operate as discussed above and will execute scripts as the scripts are received, even if the entire web page in which the script is embedded has not been loaded. Other browsers, Netscape Navigator for example, will not execute a script until the entire page has been received.

When a Netscape-type browser is used, a near real-time update can still be made to the bid box 224. That is, when a change occurs to the auction information and is sent to the webcaster server 126, script B 240 can almost immediately fulfill all pending requests for the auction information from all browsers 220, regardless of the browser type.

However, since Netscape-type browsers do not execute a script until the entire page containing the script is loaded, Netscape-type browsers do not offer the advantage of being able to hold a TCP/IP connection open while a series of scripts is received. When the webcaster server 126 receives a request from a Netscape-type browser, the webcaster server 126 may respond only when new auction information is available, just as with an Internet Explorer-type browser. After the webcaster server 126 responds to the Netscape-type browser, however, the TCP/IP connection through which the response was sent is closed. A new TCP/IP connection is opened when a new request for auction information is made, and the request is held, and the new auction information is returned through this connection when it becomes available.

The webcaster server 126 is able to determine which type of browser a request came from since browsers typically provide identifying information about themselves. The webcaster server 126 can be programmed so that after it sends a response to an Internet Explorer-type browser, it leaves the TCP/IP connection open until a recycling event is due. After the webcaster server 126 sends a response to a Netscape-type browser, the browser closes the TCP/IP connection and the webcaster server 126 will close the connection from its side next time it tries to send data.

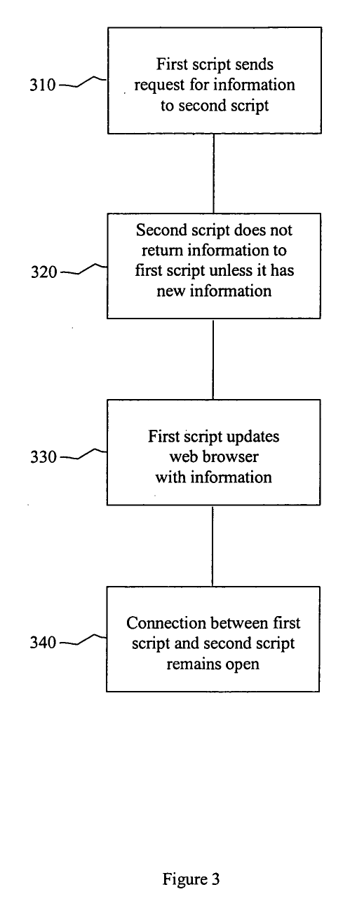

FIG. 3 illustrates a method for broadcasting high-volume web page updates. In box 310, a first software routine, such as a script, sends a request for information to a second software routine, which might also be a script. In box 320, the second software routine returns information to the first software routine only when the information is different from the previous information returned to the first software routine. In box 330, the first software routine updates a web browser with the information. In box 340, a connection between the first software routine and the second software routine is kept open after the second software routine sends the information to the first software routine.

While the above discussion has focused on auctions, it should be clear to one of skill in the art that this system and method for broadcasting updates to web pages could be used for other applications. For example, similar techniques could be used for updating information related to sporting events or stock prices, and in other situations where near real-time data updates are desirable. Use of the system described in the present disclosure allows the updating of information to be much faster, even perhaps a virtually instantaneous, because there is no need to open a new TCP/IP connection every time new information is to be broadcast. Also, the frequency of the opening and closing of numerous expensive TCP/IP connections is reduced.

While several embodiments have been provided in the present disclosure, it should be understood that the High-Volume Web Page Update System and Method may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each but may still be indirectly coupled and in communication, whether electrically, mechanically, or otherwise, with one another. Other examples of changes, substitutions, and alterations are ascertainable by one skilled in the art and could be made without departing from the spirit and scope disclosed herein.

What is claimed is:

1. A method for broadcasting an update to a web page, comprising:
a HTML (hyper-text markup language) web page executing in a browser behind a firewall and sending a request for information to a webcaster software outside of the firewall, a socket connection established for communication between the webcaster software and the HTML web page; and
in response to the request for information, the webcaster software returns the information to the HTML web page and, as the information is updated to the webcaster software, the webcaster software is operable to maintain the socket connection to provide the updated information to the HTML web page via the socket connection.

2. The method of claim 1, wherein the request from the HTML web page is further defined as a single request for information directed to the webcaster software to which the webcaster software is responsive to provide the updated information to the HTML web page via the socket connection as the information is updated to the webcaster software.

3. The method of claim 1, wherein the socket connection between the webcaster software and the HTML web page is closed and reopened on a periodic basis.

4. The method of claim 3, wherein the periodic basis is about every 10 minutes.

5. The method of claim 1, further comprising:
providing a plurality of browsers behind a plurality of firewalls sending requests for information to the webcaster software outside of the firewall, a separate socket connection established for communication between the webcaster software and the HTML web pages executing in the plurality of browsers; and
the webcaster periodically closing the plurality of separate socket connection between the webcaster software and the HTML Web pages executing in the plurality of browsers, and wherein separate socket connections are reestablished between the webcaster software and the HTML web pages executing in the plurality of browsers.

6. The method of claim 5, further comprising the webcaster closing the socket connections of a first group of browsers on a first periodic cycle and closing the socket connections of a second group of browsers on a second periodic cycle, the first periodic cycle closing socket connections before the second periodic cycles begins closing socket connections.

7. The method of claim 6, further comprising after the socket connection closing on the first periodic cycle, reestablishing separate socket connections between the webcaster software and the HTML web pages executing in the first group of browsers before closing the socket connection of the second group of browsers.

8. The method of claim 7, wherein each of the browsers initially initiate communication with the webcaster at a different time.

9. The method of claim 1, wherein the socket connection is further defined as Transmission Control Protocol/Internet Protocol connection.

10. The method of claim 1, wherein request for information by the HTML web page is generated by an Inline Frame (Iframe) element in the hyper-text markup language (HTML) code of the HTML web page.

11. The method of claim 1, further comprising:
receiving, via an interactive auction system, a bid on an auction item;
accepting, by the interactive auction system, the bid;
updating the information with the bid to a webcaster server operating the webcaster software from an auction server;
responsive to the request for information from the HTML web page, communicating the updated bid information to the HTML web page, via the socket connection;
the webcaster software facilitating maintaining the socket connection; and
upon periodically receiving during an auction a new bid, communicating the new bid to the HTML web page via the socket connection.

12. A system for updating a web page, comprising:
a device provided behind a firewall and operable to display a web page, the device operable to limit the display of information asynchronously transmitted to the device, the device further operable to request information; and
a server provided outside the firewall, the server in communication, via a connection, with the device and responsive to a request from the device for information to provide the information to the device, the server further operable to facilitate maintaining the connection with the device such that when the information is updated the server communicates the updated information to the device via the connection.

13. The system of claim 12, wherein the request from the device for information is further defined as generated by an Inline Frame (Iframe) element in hyper-text markup language (HTML) code.

14. The system of claim 12, wherein the connection is further defined as a socket connection.

15. The system of claim 14, wherein the socket connection is further defined as a Transmission Control Protocol/Internet Protocol connection.

16. The system of claim 12, wherein the device is a computer with a web browser.

17. The system of claim 16, wherein the web browser is further defined as a Microsoft Internet Explorer browser.

18. The system of claim 12, wherein the device and server communicate via the Internet.

19. The system of claim 12, wherein the device is selected from a group of devices consisting of computer systems, wireless devices, personal digital assistants, and telephony devices.

20. The system of claim 12, further comprising an auction system to maintain auction information about a subject of an auction, the auction information includes bid information which includes at least some of the information that is occasionally updated and provided to the server for communication to the device.

21. A software for updating a web page, comprising:
a remote program of substantially hyper-text markup language (HTML) code used by a web browser provided behind a firewall, the remote program operable to display a web page and request information, the display in the web page of information asynchronously transmitted being limited; and
a webcaster program deployed outside the firewall, the webcaster program operable to communicate, via a connection, with the remote program and responsive to a request from the remote program for information to provide the information, the webcaster program further operable to facilitate maintaining the connection with the remote program such that when the information is updated the webcaster program communicates the updated information to the remote program via the connection.

22. The software of claim 21, wherein the request by the remote program is generated by an
Inline Frame (Iframe) element in the remote program.

23. The software of claim 21, further comprising an Auction server managing auction information including bid information which includes at least some of the information that is occasionally updated and provided to the webcaster program for communication to the remote program.

24. The system of claim 21, wherein the connection is further defined as a socket connection.

25. A system for broadcasting an update to a web page, comprising:
a first software routine operable to send a request for information to a second software routine;
a second software routine operable to communicate via a connection to return the information to the first software routine each time the information is updated to the second software routine, the second software routine further operable to maintain the connection after transmitting the information to the first software routine for transmission of additional updated information to the first software routine; and
a web page operable to display the information received from the first software routine.

26. The system of claim 25, wherein the connection is maintained for a time period sufficient to for the second software routine to receive and transmit a plurality of updates to the information.

27. The system of claim 25, further comprising a plurality of computer systems operating the first software routine and a server operable to host the second software routine and to transmit the information to the plurality of systems each operating the first software routine via a plurality of separate connections.

28. The system of claim 27, wherein a portion of the connections between the second software routine and the plurality of systems each operating the first software routine are closed and reopened on a periodic basis.

29. The system of claim 28, wherein the connections are further defined as Transmission Control Protocol/Internet Protocol connections.

30. The system of claim 29, wherein request for information by the first software routine is generated by an Inline Frame (Iframe) element in the hyper-text markup language (HTML) code of the first software routine.
